(19) United States
(12) Patent Application Publication
(10) Pub. No.: US 2023/0177440 A1
(43) Pub. Date: Jun. 8, 2023

(54) AUDIT AND COMPLIANCE PORTAL SERVICE

(71) Applicant: NCR Corporation, Atlanta, GA (US)

(72) Inventors: Deepak Munjal, New Delhi (IN); Ritika Chaurasia, Pradesh (IN); Sidak Kaur, Chandigarh (IN)

(21) Appl. No.: 17/543,832

(22) Filed: Dec. 7, 2021

(51) Int. Cl. G06Q 10/06; G06Q 10/10

(52) U.S. Cl. CPC G06Q 10/06393; G06Q 10/10

(57) ABSTRACT

An audit and compliance portal service is provided. A retailer is authenticated to systems of the retailer and for access to the portal in a single sign-on. An interface is provided for the retailer to search and gather data and event information relevant to their systems. Audit or compliance reports can be requested or generated through the interface from the data and event information. Existing and previous reports can be browsed and downloaded from the portal using the interface. Retailer-specific workflows for audit and compliance procedures are documented and accessible from the portal through the interface.

### BACKGROUND

Increasingly retailers are outsourcing their services to cloud-based third-party service organizations. Internal operations and customer-facing operations are handled via these third-party organizations. This arrangement allows staff of the retailers to focus on their core competencies and leaves maintenance and support of the retailers' systems to organizations having technology core competencies.

Retailers are also subjected to a variety of internal/external audits and compliance regulations that are imposed by governments and imposed by trade organizations. Audit and compliance reports require a plethora of information dispersed throughout the retailers' systems. This means that retailers have to rely on ad hoc gathering of electronic captured data from whatever internal systems they maintain and from their third-party providers.

Each time a report is needed a significant time lag is often experienced by a retailer between the time the data is requested and the time that the report is provided. Some third-party providers require that the audit or compliance reports be requested through a specific employee or department, which means when the responsible person is out of the office or leaves the employment of the provider further delays can be experienced by the retailer. Retailers also rely on designated staff or departments for initiating the data gathering from the providers and producing the reports, such these these internal personnel or internal departments can also create impediments to timely generating of reports.

In fact, the only thing reliable about collecting/compiling data for audit and compliance reporting is that the entire process is ad hoc, cumbersome, fraught with error, personnel/department dependent, and time consuming.

### SUMMARY

In various embodiments, a system and methods for an audit and compliance portal service are presented.

According to an embodiment, a method for operating an audit and compliance portal service is provided. Event data and log data is collected from systems of a retailer. Metrics are generated from the event data and log data. The metrics are mapped to a type of report and the report is generated from the metrics. The report is provided through a portal interface.

### BRIEF DESCRIPTION OF THE DRAWINGS

FIG. 1 is a diagram of a system for providing and operating an audit and compliance portal service, according to an example embodiment.

FIG. 2 is a diagram of a method for operating an audit and compliance portal service, according to an example embodiment.

FIG. 3 is a diagram of another method for operating an audit and compliance portal service, according to an example embodiment.

### DETAILED DESCRIPTION

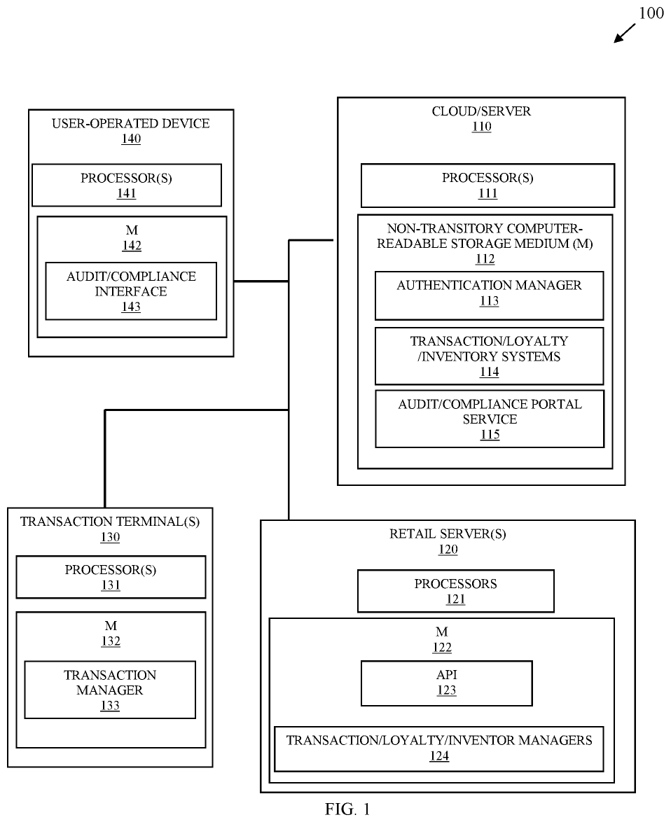

FIG. 1 is a diagram of a system/platform 100 for providing and operating an audit and compliance portal service, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of providing and operating an audit and compliance portal service, presented herein and below.

System 100 provides a cloud/server 110 as an audit and compliance portal service 115 accessible to retailers as a centralized location to search for and gather system information, system metrics, and system events for systems of the retailers. Specific audit or compliance reports can be requested. A workflow associated with a given retailer's audit and compliance procedures are documented and accessible through the portal service 115. Moreover, resource contacts with respect to any given report or given workflow are documented and provided through the portal service 115. Additionally, retailers can access the portal through a single sign on (SSO) with access to other systems of the retailers hosted by cloud/server 110.

The terms “user” refers to an individual that utilizes is authorized to access cloud/server 110 on behalf of a given retailer and request audit and compliance reports and information for a given retailer.

An “audit” refers to an inspection or evaluation of a retailer's accounts performed by an independent entity. A “compliance report” refers to an organizational (e.g., trade group, shareholder bylaws, etc.) or a governmental report produced from a retailer's electronic data (transactional, security, loyalty, inventory, etc.) that comprises a summary of or fine-grain details of predefined data types in a predefined format required by the organizational or governmental entity.

Cloud/server 110 comprises at least one processor 111 and a non-transitory computer-readable storage medium 112. Medium 112 comprises executable instructions for an authentication manager 113, transaction/loyalty/inventory systems 114, and an audit/compliance portal service 115. The executable instructions when provided to processor 111 from medium 112 cause the processor 111 to perform operations discussed herein and below with respect to 113-115.

Each retail server 120 comprises at least one processor 121 and a non-transitory computer-readable storage medium 122. Medium 122 comprises executable instructions for an Application Programming Interface (API) 123 and transaction/inventory/loyalty managers 124. The executable instructions when provided to processor 121 from medium 122 cause processor 121 to perform operations discussed herein and below with respect to 123 and 124.

Each transaction terminal 130 comprises at least one processor 131 and a non-transitory computer-readable storage medium 132. Medium 132 comprises executable instructions for a transaction manager 133. The executable instructions when provided to processor 131 from medium 132 cause processor 131 to perform operations discussed herein and below with respect to 133.

User-operated device 140 comprises at least one processor 141 and a non-transitory computer-readable storage medium 142. Medium 142 comprises executable instructions for an audit/compliance interface 143. The executable instructions when provided to processor 141 from medium 142 cause processor 141 to perform operations discussed herein and below with respect to 143.

A given retailer hosts their systems 114 via cloud/server 110 and is accessible from retail servers 120 via API 123. Transaction terminals 130 of the retailers perform transactions of customers via transaction manager 133 through interaction with the corresponding transaction/loyalty/inventory managers 124, which update the corresponding systems 114 of cloud/server 110 via API 123.

Each retailer maintains a plurality of workflows for audits and compliance reports. Each workflow includes a documented readable procedure and types of data required to conduct and audit or generate a compliance report. Moreover, each workflow comprises contact information for resources responsible for a given portion of the workflow. In an embodiment, each workflow is also represented as a control data structure (such as a schema) than can be interpreted and processed by audit/compliance portal service 115.

As systems 114 are hosted and processed from cloud/server 110, events and logs are captured as audit data. The audit data is maintained per retailer based on that retailer's systems 114. Metrics are maintained for different types of audit data. For example, security events raised; maintenance and service events raised per given terminal 130, per given set of terminals 130 within a given store, and per multiple stores of a retailer; types of security events by total by terminal 130, by store, and by retailer; total transactions processed per terminal 130, per retail store, per all stores of a given retailer; total online transaction processed per store and per retailer; total unredeemed loyalty points maintained in loyalty accounts of the retailer over a given period of time; total offers redeemed over the given period of time; total value of offers redeemed over the given period of time; total logins to a given retail server over the given period of time; total new customers enrolled in a loyalty account of a retailer over the given period of time; total sales per store, per terminal 130, and per retailer; total returns per store, per terminal 130, and per retailer; total payment cards processed per terminal 130, per store, and per retailer over the given period of time; total successful and unsuccessful payment card transaction per terminal 130, per store, and per retailer over the given period of time; total known fraudulent payment card transaction and total fraudulent value per terminal 130, per store, and per retailer over the given period of time; total cash transaction per terminal 130, per store, and per retailer over the given period of time; and others metrics based on the data types and event types for the logs and security events.

In an embodiment, a user can operate audit/compliance interface 143 to define custom metrics to capture based on a given retailer's data types captured in events and logs of the corresponding retailer's systems 114. Audit/compliance portal service 115 maintains a schema for the metrics, which allows service 115 automatically maintain custom metrics for a given retailer from the events and logs of that retailer's systems 114.

A user also operates audit/compliance interface 143 to interact with audit/compliance portal service 115 and defines reports and the metrics required for each report for a given retailer. Additionally, the workflows and contacts associated with portions of each workflow are defined by the user through audit/compliance interface 143.

Once a user of a given retailer has defined their events data, log data, reports, and workflows. Audit/compliance portal service 115 is configured to monitor the events data and the log data and generate audit and compliance reports at user-defined intervals of time or based on a user-defined event being detected within that retailer's systems 114.

Cloud/server 100 maintains the events and logs per retailer for that retailer's systems 114 along with control data associated with that retailer, such as data types, event types, report definitions, report generation criteria, and workflows for any given audit or compliance report. Interface 143 permits a user of a given retailer to log into cloud/server 110 via authentication manager 113.

Authentication manager 113 maintains a single-sign on (SSO) for access to the retailer's systems 114 and for access to audit and compliance reporting through audit/compliance portal service 115. The retailer defines access controls per user identifier of the retailer, some users may be customers of the retailer while other users are employees of agents of the retailers. The access control list permits authentication manager 113 to authenticate a given user logging in to cloud/server 110 and validate registered credentials and assign a security role for the appropriate degree of access permitted by the retailer to the retailer's systems 114 and to portal service 115.

When an authenticated user has access control that permits interaction with portal service 115. The degree of access to reports can vary based on the user's assigned security role. For example, one user may have access to metrics of a particular retailer's system 114 (such as transaction system) while another user may have access to metrics of all the retailer's systems 114 (such as transaction system, loyalty system, and inventory system). Some users may have assigned roles that permits downloading specific compliance or audit reports but not request or generate the corresponding report. Some user may have assigned roles that permits the user to define and change the metrics gathered, reports, and workflows.

Interface 143 permits authorized users to search for a given report having specific criteria or a specific report name or report type. A user can browse report types by time period, request a new report, or define a report. A user can also trigger a specific audit report or a specific compliance report that is updated from a prior produced report. Reports can be searched based on a specific line of business for the retailer, such as by hospitality, by banking, etc.

In an embodiment, portal service 115 permits benchmarks to be set for various metrics of any given report through interface 143. Portal service 115 monitors the metrics for compliance to the corresponding benchmark and can raise a notification with a given benchmark is not being met as set by the retailer. The benchmark can be linked to predefined advice that is presented in the notification as to how the benchmark can be corrected or improved. For example, an unauthorized access metric to systems 114 may have a benchmark total for a given period of time that is exceeded for that period of time, indicating in the predefined advice that two-factor authentication or stricter password requires of users to access systems 114 are needed to reduce the unauthorized access metric total. As another example, an average credit card processing time may exceed a benchmark indicating in the advice that the network connections with the paying entities needs to be improved or that card readers require updating at the terminals 130.

In an embodiment, portal service 115 also maintains technical guides for advice given on a given benchmark, a peripheral of a given terminal 130, or a terminal. Service logs of systems 114 can be linked to given benchmarks and the advice linked to a specific section of a given technical guide. In this way, fine-grain instructions on resolving a problem can be provided to the user of interface 143.

In an embodiment, portal service 115 is configured to send real-time reports or notifications to resources (managers, technical staff, sales, etc.) via email or text messages using contact data defined in the workflows for a given report or a given benchmark of a given report. The notifications may include the data that precipitated the notifications, such as relevant log data, event data, metrics, technical guides, and contact data for resources needed to address the missed benchmark.

System 100 hosts systems 114 for retailers and collects event and log data produced by those systems 114. Interface 143 permits a designated user of a given retailer who has the proper access control to define metrics from the even and log data per system 114, per custom collection of systems 114, and per all retailer systems 114. The designated user can also custom define reports that detail collections of metrics from the systems 114 over user-defined periods of time. Benchmarks can be provided as triggers to generate reports or notifications when such benchmarks are not met. Workflows defining the procedures of assembling audit and compliance reports (and any benchmarks) are provided through interface 143. System 100 acts as a centralized data store for metrics, reports, technical information (advice and guides), and benchmark monitoring. This solves issues associated with existing techniques which are ad hoc, fraught with errors, and time consuming and provides a portal (cloud/server 110) for SSO of retail users, access control, and on demand access to any needed report, benchmark comparisons, and technical support.

In an embodiment, transaction terminals 130 are a combination of terminals 130 that comprise Self-Service Terminals (SSTs), kiosks, Automated Teller Machines (ATMs), and Point-Of-Sale (POS) terminals.

In an embodiment, user-operated device 140 may be a phone, a tablet, a laptop, a desktop, or a wearable processing device.

In an embodiment, transaction terminal 130 operates in a transaction mode and an administrative mode of operation and includes audit/compliance interface 143, such that during the administrative mode of operation a user can interact with portal service 115.

In an embodiment, manager 124 utilize API 123 to interact with portal service 115 for purposes of requesting metrics, benchmark comparisons, reports, or technical advice. Automated logic of managers 123 trigger interaction with portal service 115 through API 123. In this way, the reporting and benchmark analysis of portal service 115 can be obtained and processed in an automated manner without specific user requests through interface 143.

In an embodiment, portal service 115 is processed to provide a given retailer audit and compliance reports compliance with Payment Card Industry (PCI), Security Operation Center (SOC), Federal Financial Institutions Examination Council (FFIEC), Business Continuity Reports, Security White Papers, network Penetration Test Reports, etc.

In an embodiment, the store is a bank branch, and the retailer is a bank. As used herein above and below, “store” may be used interchangeably with “bank branch” and “retailer” may be used interchangeably with “bank.”

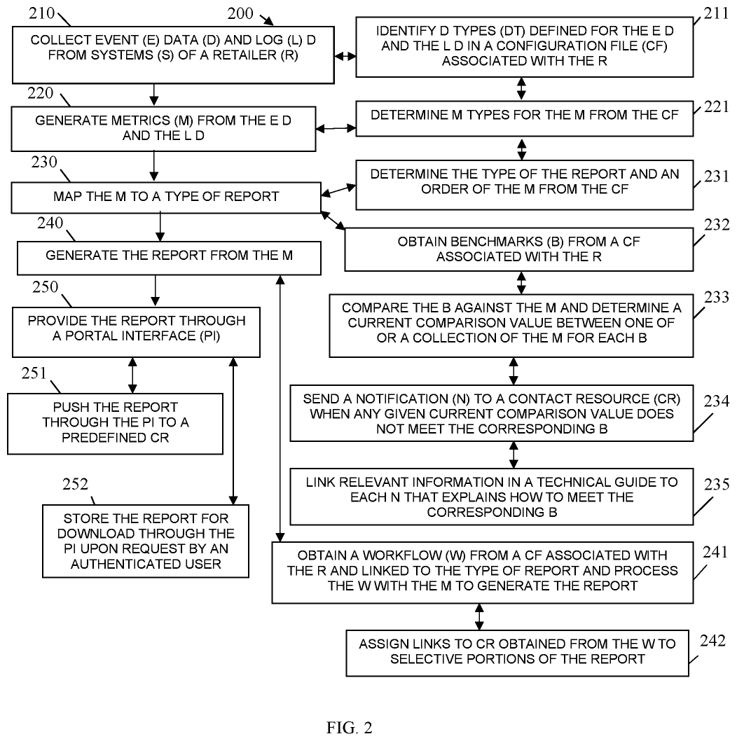

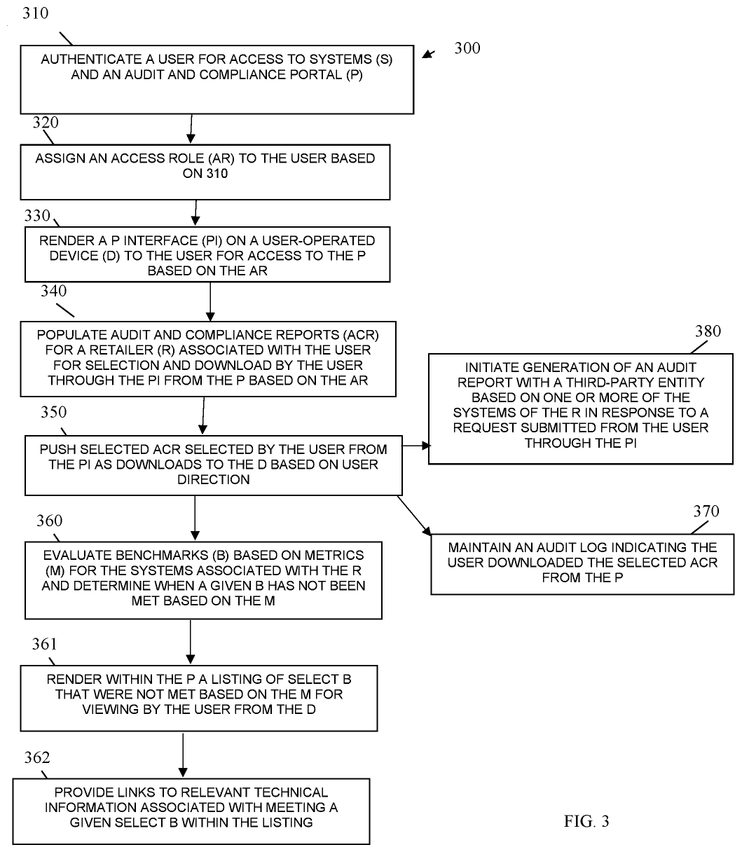

The above-referenced embodiments and other embodiments are now discussed with reference to FIGS. 2 and 3.

FIG. 2 is a diagram of a method 200 for operating an audit and compliance portal service, according to an example embodiment. The software module(s) that implements the method 200 is referred to as an “audit and compliance portal service.” The audit and compliance portal service is implemented as executable instructions programmed and residing within memory and/or a non-transitory computer-readable (processor-readable) storage medium and executed by one or more processors of one or more devices. The processor(s) of the device that executes the audit and compliance portal service are specifically configured and programmed to process the audit and compliance portal service. The audit and compliance portal service may have access to one or more network connections during its processing. The network connections can be wired, wireless, or a combination of wired and wireless.

In an embodiment, the device that executes the audit and compliance portal service is cloud 110 or cloud processing environment 110. In an embodiment, the device that executes the audit and compliance portal service is server 110.

In an embodiment, the audit and compliance portal service is all or some combination of 113, 114, and/or 115.

At 210, the audit and compliance portal service collects event data and log data from systems 114 of a retailer.

In an embodiment, at 211, the audit and compliance portal manager identifies data types defined for the event data and the log data in a configuration file associated with the retailer.

At 220, the audit and compliance portal manager generates metrics from the event data and the log data.

In an embodiment of 211 and 220, at 221, the audit and compliance portal manager determines the metric types from the configuration file.

At 230, the audit and compliance portal manager maps the metrics to a type of report.

In an embodiment of 221 and 230, at 231, the audit and compliance portal manager determines the type of the report and an order of the metrics from the configuration file.

In an embodiment, at 232, the audit and compliance portal manager obtains benchmarks from the configuration file associated with the retailer.

In an embodiment of 232 and at 233, the audit and compliance portal manager compares the benchmarks against the metrics and determines a current comparison value between one or more or a collection of the metrics and each of the benchmarks.

In an embodiment of 233 and at 234, the audit and compliance portal manager sends a notification to a contact resource when any given current comparison value does not meet the corresponding benchmark.

In an embodiment of 234 and at 235, the audit and compliance portal manager links relevant information in a technical guide to each notification that explains how to meet the corresponding benchmark.

At 240, the audit and compliance portal manager generates the report from the metrics.

In an embodiment, at 241, the audit and compliance portal manager obtains a workflow from a configuration file associated with the retailer and linked to the type of report; the audit and compliance portal manager processes the workflow with the metrics to generate the report.

In an embodiment of 241 and at 242, the audit and compliance portal manager assigns links to a contact resource obtained from the workflow to selective portions of the report.

At 250, the audit and compliance portal manager provides the report through a portal interface 143.

In an embodiment, at 251, the audit and compliance portal manager pushes the report through the portal interface 143 to a predefined contact resource.

In an embodiment, at 252, the audit and compliance portal manager store the report for download through the portal interface 143 upon requested by an authenticated user with an appropriate access role.

FIG. 3 is a diagram of another method 300 for operating an audit and compliance portal service, according to an example embodiment. The software module(s) that implements the method 300 is referred to as a “audit and compliance portal manager.” The audit and compliance portal manager is implemented as executable instructions programmed and residing within memory and/or a non-transitory computer-readable (processor-readable) storage medium and executed by one or more processors of a device. The processors that execute the audit and compliance portal manager are specifically configured and programmed for processing the audit and compliance portal manager. The audit and compliance portal manager may have access to one or more network connections during its processing. The network connections can be wired, wireless, or a combination of wired and wireless.

In an embodiment, the device that executes the audit and compliance portal manager is cloud 110 or cloud processing environment 110. In an embodiment, the device that executes the audit and compliance portal manager is server 110.

In an embodiment, the audit and compliance portal manager is some combination or all of 113, 114, 115, and/or method 200.

The audit and compliance portal manager presents another and, in some ways, an enhanced processing perspective from that which was shown above for system 100 and/or method 200.

At 310, the audit and compliance portal manager authenticates a user for access to systems 114 and an audit and compliance portal 110.

At 320, the audit and compliance portal manager assigns an access role to the user based on 310.

At 330, the audit and compliance portal manager renders a portal interface 143 on a user-operated device 140 to the user for access to the audit and compliance portal 110 based on the access role.

At 340, the audit and compliance portal manager populates audit and compliance reports for a retailer associated with the user for selection and download by the user through the portal interface 143 from the audit and compliance portal 110 based on the access role of the user. For example, a given access role may permit the user to access all audit and compliance reports whereas a different access role may permit the user to only access select compliance reports and no audit reports.

At 350, the audit and compliance portal manager pushes selected audit and compliance reports selected by the user from the portal interface 143 as downloads to the user-operated device 140 based on user direction of selection of a download option within the portal interface 143.

In an embodiment at 360, the audit and compliance portal manager evaluates benchmarks based on metrics of the systems associated with the retailer and determines when a given benchmark has not been met based on the metrics.

In an embodiment of 360 and at 361, the audit and compliance portal manager renders within the audit and compliance portal 110 a listing of select benchmarks that were not met based on the metrics for viewing by the user from the user-operated device 140 through the portal interface 143.

In an embodiment of 361 and at 362, the audit and compliance portal manager provides links to relevant technical information associated with meeting a given select benchmark within the listing.

In an embodiment, at 370, the audit and compliance portal manager maintains an audit log indicating the user downloaded the selected audit and compliance reports from the audit and compliance portal 110.

In an embodiment, at 380, the audit and compliance portal manager initiates generation of an audit report with a third-party entity based on one or more of the systems of the retailer in response to a request submitted from the user through the portal interface 143.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
collecting event data and log data from systems of a retailer;
generating metrics from the event data and the log data;
mapping the metrics to a type of report;
generating the report from the metrics; and
providing the report through a portal interface.

2. The method of claim 1, wherein collecting further includes identifying data types defined for the event data and the log data in a configuration file associated with the retailer.

3. The method of claim 2, wherein generating the metrics further includes determining metric types for the metrics from the configuration file.

4. The method of claim 3, wherein mapping further includes determining the type of the report and an order of the metrics from the configuration file.

5. The method of claim 1, wherein mapping further includes obtaining benchmarks from a configuration file associated with the retailer.

6. The method of claim 5, wherein obtaining further includes comparing the benchmarks against the metrics and determine a current comparison value between one of or a collection of the metrics for each benchmark.

7. The method of claim 6 further comprising, sending a notification to a contact resources when any given current comparison value does not meet the corresponding benchmark.

8. The method of claim 7, wherein sending further includes linking relevant information in a technical guide to each notification that explains how to meet the corresponding benchmark.

9. The method of claim 1, wherein generating the report further includes obtaining a workflow from a configuration file associated with the retailer and linked to the type of report and processing the workflow with the metrics to generate the report.

10. The method of claim 9, wherein processing the workflow further includes assigning links to contact resources obtained from the workflow to selective portions of the report.

11. The method of claim 1, wherein providing further includes pushing the report through the portal interface to a predefined contact resource.

12. The method of claim 1, wherein providing further includes storing the report for download through the portal interface upon request by an authenticated user.

13. A method, comprising:
authenticating a user for access to systems and an audit and compliance portal;
assigning an access role to the user based on the authentication;
render a portal interface on a user-operated device to the user for access to the audit and compliance portal based on the access role;
populating audit and compliance reports for a retailer associated with the user for selection and download by the user through the portal interface from the audit and portal based on the access role; and
pushing selected audit and compliance reports selected by the user from the portal interface as downloads to the user-operated device based on user direction.

14. The method of claim 13 further comprising, evaluating benchmarks based on metrics associated with the retailer and determining when a given benchmark has not been met based on the metrics.

15. The method of claim 14 further comprising, rendering within the audit and compliance portal a listing of select benchmarks that were not met based on the metrics for viewing by the user from the user-operated device.

16. The method of claim 15 further comprising, providing links to relevant technical information associated with meeting a given select benchmark within the listing.

17. The method of claim 13 further comprising, maintaining an audit log indicating the user downloaded the selected audit and compliance reports from the audit and compliance portal.

18. The method of claim 13 further comprising, initiating generation of an audit report with a third-party entity based for one or more of the systems of the retailer in response to a request submitted from the user through the audit and compliance portal interface.

19. A system, comprising:
a cloud processing environment comprising hosted systems of a retailer and an audit and compliance portal;
wherein the cloud-processing environment is configured to:
provide single-sign on to users of the retailer for access to the hosted systems and the audit and compliance portal;
assign a given user an access role associated with access to the audit and compliance portal based on authentication of the user during the single-sign on;
maintain configuration files for the retailer that define event data and log data produced by the systems, define metrics associated with the event data and the log data, and that define report types for reports;
capture the event data and the log data in accordance with the configuration files;
maintain the metrics based on the event data and the log data and in accordance with the configuration files;
generate the reports of the report types based on the metrics in accordance with the configuration files;
render a portal interface for access to the audit and compliance portal on a user-operated device of the give user based on the access role;
present a listing of available reports to the user through the portal interface; and
downloading select available reports to the user-operated device upon selection by the user from the listing through the portal interface.

20. The system of claim 19, wherein the cloud-processing environment is further configured to:
initiate generation of a new report based on a request submitted by the user through the portal interface;
initiate generation of an audit report with a third-party entity based on the metrics associated with one or more of the hosted systems and the configuration files;
send a notification to contact resource defined in the configuration files when a benchmark defined in the configuration files is not met based on select metrics defined in the configuration files; and
linking technical information relevant to the benchmark to the notification for access by the contact resource through the audit and compliance portal to modify the one or more systems to meet the benchmark and verifiable through revised metrics during operation of the one or more systems.
